(19) United States
(12) Patent Application Publication
(10) Pub. No.: US 2013/0144796 A1
(43) Pub. Date: Jun. 6, 2013

(54) ASSIGNING CONFIDENCE VALUES TO AUTOMATED PROPERTY VALUATIONS BY USING THE NON-TYPICAL PROPERTY CHARACTERISTICS OF THE PROPERTIES

(71) Applicants: Hamilton Fout, Rockville, MD (US); Yong Chen, Potomac, MD (US); Elif Onmus-Baykal, Arlington, VA (US); Eric Rosenblatt, Derwood, MD (US); WenXiong W. Yao, Rockville, MD (US)

(72) Inventors: Hamilton Fout, Rockville, MD (US); Yong Chen, Potomac, MD (US); Elif Onmus-Baykal, Arlington, VA (US); Eric Rosenblatt, Derwood, MD (US); WenXiong W. Yao, Rockville, MD (US)

(73) Assignee: Fannie Mae, Washington, DC (US)

(21) Appl. No.: 13/312,372

(22) Filed: Dec. 6, 2011

(51) Int. Cl. G06Q 50/16

(52) U.S. Cl. 705/306

(57) ABSTRACT

Automatically assigning confidence ratings to properties valued by an automated valuation model. A value confidence model determines a set of typical property characteristics for properties in a geographic area, automatically determines a deviation from the set of typical property characteristics for a candidate comparable property, and assigns a confidence factor to an automated valuation of the candidate comparable property based upon the deviation.

### BACKGROUND OF THE INVENTION

1. Field of the Invention

This application relates generally to automated valuation models (AVM), more particularly to a value confidence model for confidence valuation of automated valuations of unusual properties based on the characteristics that make those properties unusual, and still more particularly to noting a significant deviation of a property by the value confidence model and assigning a lower confidence value to that property if it is found to be atypical.

2. Description of the Related Art

What is needed is a value confidence model that emulates a sales comparison approach used by appraisers and to consequently provide an alternative valuation opinion for a given conventional appraisal in mortgage lending.

Determining whether a property is appropriately valued, whether accurate comparables sales are selected for said valuation, or whether the relative value of a home or property is congruent to other properties in a geographic region is very difficult without extensive knowledge of a particular property, the surrounding areas, and the relative history of that property. Appraisers themselves and the appraisals they render are currently the main source for property values.

Yet, while most appraisals can be assumed to be accurate, performing quality assurance on appraisals requires another appraiser to perform a second evaluation on a property to prove that the first appraisal was an accurate evaluation. In addition, due to the required extensive knowledge as detailed above, the limited human ability to analyze and compute such information, and the length of time required by human evaluations, automatic verification possesses a public benefit. And since there is no current method for an automatic confidence valuation of an appraisal, the below described invention offers and details a faster way to judge appraisal accuracy and quality without the need for additional human evaluations and appraisals.

### SUMMARY OF THE INVENTION

The present invention relates to a method for automatically assigning confidence ratings to properties valued by an automated valuation model that comprises determining a set of typical property variables for properties in a geographic area, automatically determining a deviation from the set of typical property variables for a candidate comparable property, and assigning a confidence factor to an automated valuation of the candidate comparable property based upon the deviation.

Further, determining a set of typical property variables for properties in a geographic area may include selection of a set of subject-level variables and a determination of whether the geographic area is the smallest available geographic area with at least ten transactions.

Furthermore, assigning a confidence factor may include estimating a probability that the automatic valuation is within ±10 percent of a value. Alternatively, assigning a confidence factor may include applying a logistic regression that estimates a probability that a given comparable sales model prediction is within 10 percent of the transacted price.

In addition, the set of typical property variables may include a set of property characteristics, model uncertainty, comparable strength, market segmentation, and geographic area.

An alternative embodiment may include a computer program product stored on a non-transitory computer readable medium that when executed by a computer performs a method for automatically assigning confidence ratings to properties valued by an automated valuation model or an apparatus implementing a circuit that based a set of typical property characteristics for properties in a geographic area and a deviation from the set of typical property characteristics for a candidate comparable property performs a confidence factor calculation for the candidate property.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIGS. 1A-B are block diagrams illustrating examples of systems in which a value confidence application operates;

FIGS. 2A-B are block diagrams illustrating examples of a value confidence application;

FIG. 3 is a flow diagram illustrating an example of a value confidence process.

FIG. 4 is a pie graph showing a contribution to PPE10 Variation in VCM for Washington, DC MSA.

FIG. 5 is a line graph showing a normalized logged LOT Variable vs a Normal Distribution for Washington, DC MSA.

FIG. 6 is a flow diagram illustrating an example of an automated valuation process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described.

The described relates to using automated valuation models to speed up the process of arriving at reasonable values for a property. However, properties that are not average will often be given values that are not appropriate to them. Yet, while it is difficult for automated valuation models to value unusual properties based on the characteristics that make them unusual, the characteristics can be used to power a value confidence model. The valuation confidence model takes note of any significant deviation of a property from what is typical in the geographic region and assigns lower confidence values where properties are atypical.

Further, the value confidence model provides a confidence measure of how close a valuation model prediction is to the actual purchase price of the property based on historical transaction data. Higher confidence indicates a greater degree of reliability in using the valuation model to evaluate an appraiser's opinion. It is preferred that the output of both the valuation model and value confidence model are used to assess the quality of appraisals, evaluate properties, and evaluate potential collateral risk of loans.

Furthermore, the value confidence model estimates the probability that the value prediction by the automatic valuation model is within ±10 percent of the transacted value if the property is sold at a particular date. At the aggregate level, this measure is called the Proportion of Prediction Error within 10 percent (PPE10). Thus, the combined calculations by the value confidence model and the automated valuation model produce not only a valuation tool but also a collateral risk management tool that may be the source for evaluating appraisal comparable selection and adjustments. In addition, the value confidence can also 1) consider the abnormality of the property relative its neighborhoods by more accurately evaluating subjects with characteristics that conform to the surrounding neighborhood; 2) estimate at the metropolitan statistical area (MSA) level to reflect unique characteristics of each local market; and 3) considers factors specific to the automatic valuation model that predict model performance, including size, and quality of comparable pool.

In other words, the value confidence model answers the questions of “what is a comparable's strength?” or “how alike is a comparable to a subject?” Because when comparables are more similar than not to the subject, the automated valuation model performs better. Therefore, the value confidence model calculates the weight of a comparable with reliance on a regression framework using property characteristics to answer the question of similarity. In addition, please note that although a comparable sales model and an automated valuation model are different models, they both may integrate with or use the results of a value confidence model. Thus, in the below description, these models are used interchangeably when describing the function of the value confidence model.

In testing, the value confidence model uses the most recent 12 months of available transactions that can be run through the automatic valuation model or comparable sales model to estimate the probability that the model's (whether the automatic valuation or the comparable sales model's) prediction will be within 10 percent of transacted price using a set of broad model inputs available at the county level at the time of property valuation (Datappraise), but before a transaction price is realized. The broad model inputs include a set of property characteristics, model uncertainty, comparable strength, market segmentation, and geographic area.

Property characteristics, such as gross living area (GLA), lot size (LOT), property age (AGE), and number of baths (BTH), affect model reliability in at least two ways. First, the comparable sales model performs better on the typical properties, while performing poorly on atypical properties. This is because parameter estimates are weighted more by typical properties and because there are more quality comparables available for typical properties than for atypical ones. Second, when characteristics are omitted from or measurements are in error when calculating an estimation, the model is no longer conditioned on these variables. Thus, the model's performance along these dimensions is potentially predictable.

Model Uncertainty relates to the unreliability of model predictions when there is more volatility in the residuals of the model. The residual variance (σ²) is calculated at the census block group (CBG), census tract, and county level, moving from smallest to largest geographic region of the property. The value confidence model uses the volatility measure of the smallest geographic area where the volatility is accurately calculated (i.e. at least 10 observations).

Comparable strength is an input that indicates a higher reliability for the model's prediction when there are a larger number of comparables and the comparables are more like the subject because the models rely critically on determining a property's value by analyzing the values of a suitable set of comparables. That is, the value confidence model includes the number of model comparables found by the comparable sales model for a given subject and measures the degree of comparability between the subject and comparable. The value confidence model relies on the average economic distance and the average weighted absolute location adjustments arising from the comparable sales model (or automated valuation model).

Market Segmentation is an input that tracks performance across different price segments of the comparable sales model. Further, the weighted average of unadjusted values of the comparable pool is used to approximate the relative price segment of the subject in a given market. When running the value confidence simulation, it was found that the comparable sales model performs worse for those properties within the extreme parts of the distribution, and particularly for those properties that are lower priced.

Geographic area is an input for defining the physical market boundaries. It is preferred that the value confidence model includes county-level fixed effects within the MSA and state-level estimations. This is because performance of the comparable sales model will potentially differ significantly along the different dimension, and county-level fixed effects within the MSA and state-level estimations provide a consistency with performance. To assist in understanding geographic input and MSAs, Table 1. List of Example MSAs is provided below for nine MSAs (one in each Census Division).

TABLE 1
List of Example MSAs

| Census | | |
|---|---|---|
| Division | MSA_ID | MSA Name |
| East North | 16980 | Chicago-Naperville-Joliet, IL-IN-WI |
| Central | | |
| East South | 34980 | Nashville-Davidson--Murfreesboro--Franklin, |
| Central | | TN |
| Middle | 35620 | New York-Northern New Jersey-Long Island, |
| Atlantic | | NY-NJ-PA |
| Mountain | 38060 | Phoenix-Mesa-Scottsdale, AZ |
| New | 14460 | Boston-Cambridge-Quincy, MA-NH |
| England | | |
| Pacific | 31100 | Los Angeles-Long Beach-Santa Ana, CA |
| South | 47900 | Washington-Arlington-Alexandria, |
| Atlantic | | DC-VA-MD-WV |
| West North | 28140 | Kansas City, MO-KS |
| Central | | |
| West South | 26420 | Houston-Sugar Land-Baytown, TX |
| Central | | |

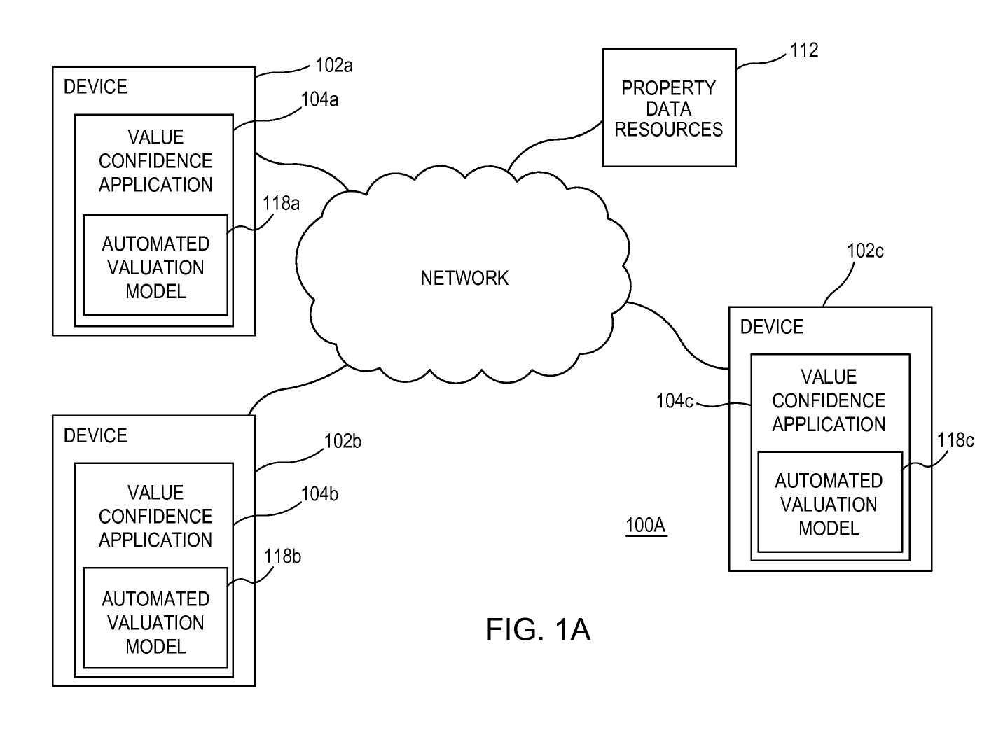

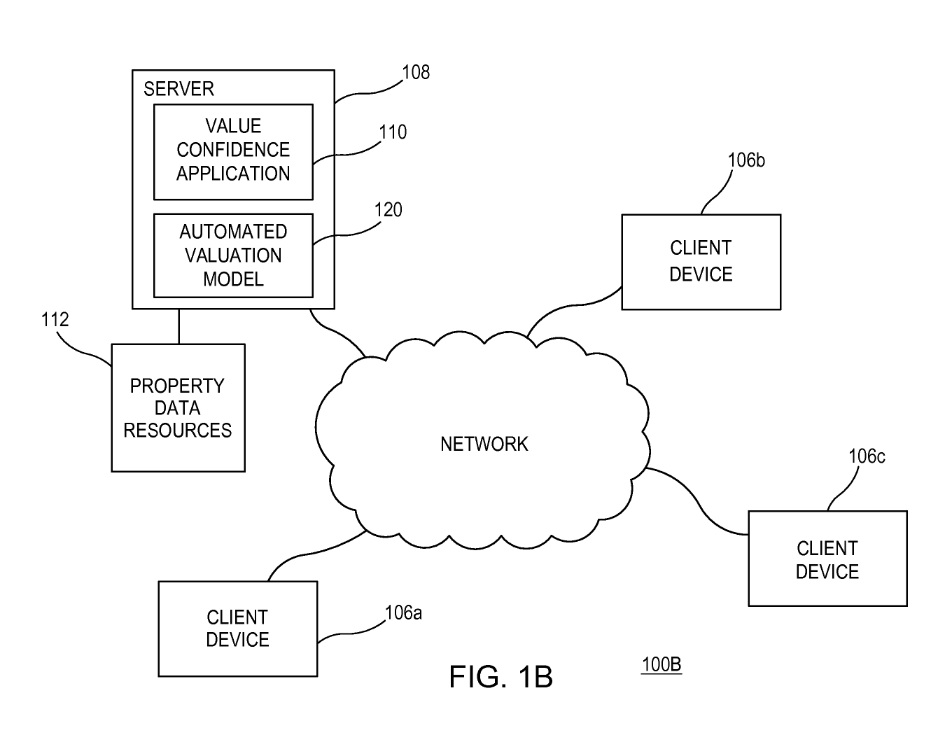

A description of the systems in which a value confidence model operates will now be given below. FIGS. 1A-B are block diagrams illustrating examples of systems in which a value confidence application operates. Specifically, FIG. 1A is block diagram illustrating an example of a system 100A in which the value confidence applications 104a-c operate.

FIG. 1A further illustrates several user devices 102a-c each having the value confidence applications 104a-c installed thereon. The user devices 102a-c are preferably computer systems, which may be referred to as workstations, although they may be any conventional computing or electronic devices, such as personal computers, laptop personal computers, mobile phones, smart-phones, super-phones, tablet personal computers, personal digital organizers, and the like. The network over which the devices 102a-c (through their interfaces, which are not shown) may communicate may also implement any conventional technology, including but not limited to cellular, WiFi, WLAN, LAN, or combinations thereof. Alternatively, the user devices 102a-c may be configured as web terminals where the value confidence applications 104a-c are configured to run in the context of the functionality of a web browser application. This configuration may also implement a network architecture wherein any of the value confidence applications 104a-c provide, share, and rely upon the other value confidence application's functionality.

As an illustrated alternative in FIG. 1B, the client devices 106a-c may respectively access a server 108, such as through conventional web browsing, with the server 108 providing the value confidence application 110 and an automated valuation model 120 for access by the client devices 106a-c. In this embodiment, the value confidence application 110 and the automated valuation model 120 are separate functions; however, the automated valuation model 120 may also be integrated into the value confidence application 110, as depicted by the automated valuation model 118a-b in FIG. 1A. Further, as another alternative, the functionality of the value confidence application 110 and the automated valuation model 120 may be divided between the computing devices and server, where either function may be located separately on either device and accessed through distributed computing. Finally, of course, a single computing device may be independently configured to include the value confidence application 110 and the automated valuation model 120, where the automated valuation model may alternatively be a comparable sales model.

As illustrated in FIGS. 1A-B, however, property data resources 112 are typically accessed externally for use by the application, since the amount of property data is rather voluminous, and since the application is configured to allow access to any county or local area in a very large geographic area (e.g., for an entire country such as the United States). Additionally, the property data resources 112 are shown as a singular block in the figure, but it should be understood that the singular block represents a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The application accesses and retrieves the property data from these resources in support of dynamically changing values for the subject, instantaneous subject valuation, estimating confidence valuation, modeling of comparable properties as well as the rendering of map images of subject properties and corresponding comparable properties, and the display of supportive data (e.g., in grid form) in association with map images.

The value confidence model itself is a logistic regression (or logit) model or approach that estimates the probability that a given comparable sales model prediction is within 10 percent of the transacted price (see PPE10 above). Further, the explanatory variables in the logit at least include:
relative logged AGE;
relative logged LOT;
relative logged GLA;
relative BTH;
average weighted comp values;
average weighted economic distance;
average weighted absolute location adjustment;
model volatility;
whether or not the property represents a foreclosure transaction;
whether or not the property is within a tenth of a mile of water;
the number of comps the comparable sales model selects for the property; and
the county of the property.
   The basic logit model can be expressed as:

$${π}_{i} = Pr ( PPE {10}_{i} = 1 \vert {X}_{i} ) = \frac{exp ( {X}_{i}^{′} β + {ɛ}_{i} )}{1 + exp ( {X}_{i}^{′} β + {ɛ}_{i} )} , \qquad ( Eq . 1 )$$

where πᵢ represents the conditional probability that the comparable sales model prediction for a subject property (indexed by i) is within 10 percent of the actual transacted price (PPE10ᵢ=1), Xᵢ represents the k×l vector of k characteristics observable at the property level at the time of comparable sales model prediction, β represents the k×l vector of coefficients to be estimated, and εᵢ represents the error term. The Xᵢ′β term represents the log-odds ratio or the expected probability that a comparable sales model prediction based on characteristics measured by Xᵢ falls within 10 percent of the transacted price:

$${X}_{i}^{′} β = E \{ log ( \frac{{π}_{i}}{1 - {π}_{i}} ) \} . \qquad ( Eq . 2 )$$

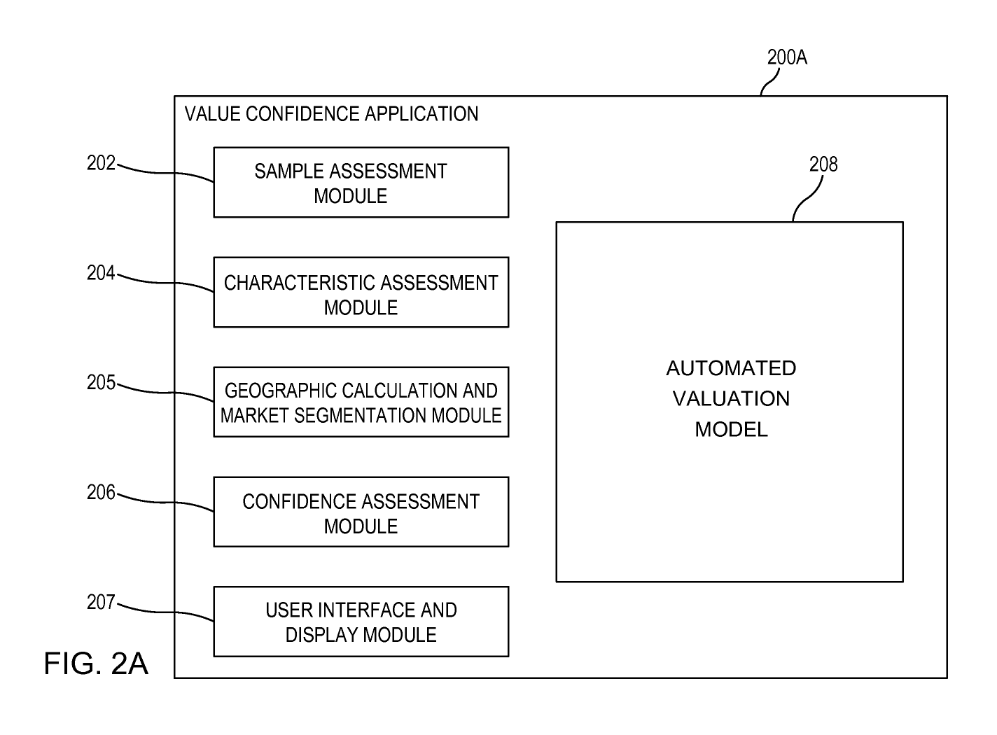

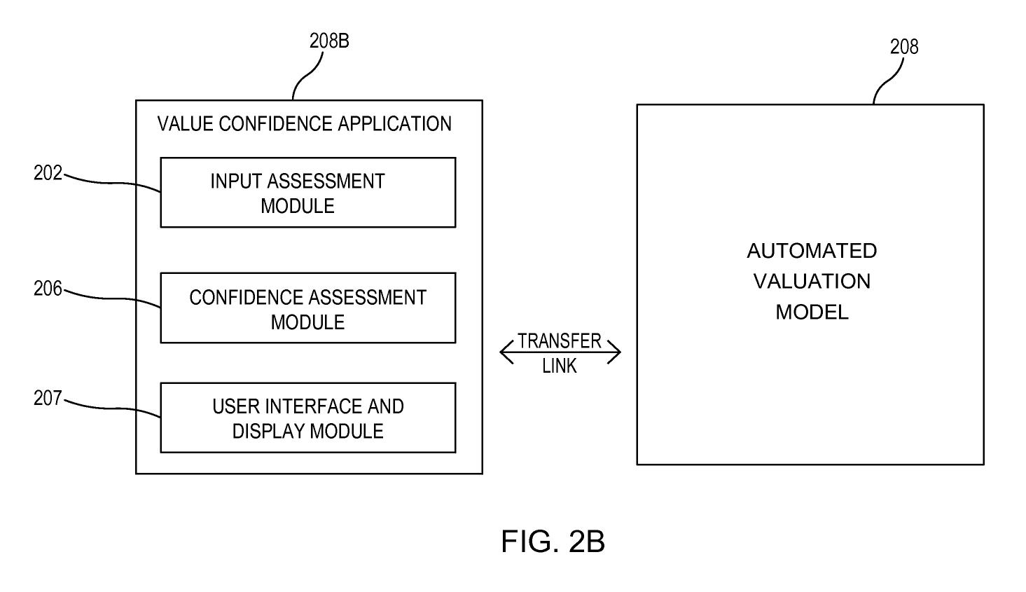

FIG. 2A-B are block diagrams illustrating examples of a value confidence application. According to one aspect, the application includes program code executable to perform an automatic confidence rating assignment to properties valued by an automated valuation model through a logit regression using explanatory variables related to a set of typical property characteristics for properties in a geographic area, where a specific candidate comparable property is given a confidence factor based its deviation from the set of typical property characteristics. Further, the application preferably comprises program code that is stored on a non-transitory computer readable medium (e.g., compact disk, hard disk, etc.) and that is executable by a processor to perform operations in support of modeling and mapping comparable properties.

Specifically, FIG. 2A is a block diagram illustrating an example of the value confidence application 200A where automated valuation model 208 is integrated into the application. For example, the value confidence application 200A is preferably provided as software on a device (102a-c), but may alternatively be provided as hardware or firmware, or any combination of software, hardware and firmware. The application 200A is configured to provide a confidence valuation based on at least the inputs of a set of property characteristics, model uncertainty, comparable strength, market segmentation, and geographic area using the automated valuation model's 208 functionality. Although one modular breakdown of the application 200A is offered, it should be understood that the same functionality may be provided using fewer, greater or differently named modules.

The example of the application 200A of FIG. 2A includes a sample assessment module 202, a characteristic assessment module 204, a geographic calculation and market segmentation module 205, a confidence assessment module 206, a user interface and display module 207, and the automated valuation model 208. And although it is not shown, the application 200A further includes an application programmable interface (API) module for connecting the application with other software and hardware as required by computer platforms, such that the application may communicate directly with other applications, modules, models, and devices through both physical and virtual interfaces; however, the application programmable interface module may be integrated with any of the described functions of the application.

The sample assessment module 202 includes program code for calculating model uncertainty and comparable strength and outputting the results to the confidence assessment module 206.

The characteristic assessment module 204 includes program code for property characteristics, such as gross living area (GLA), lot size (LOT), property age (AGE), and number of baths (BTH).

The geographic calculation and market segmentation module 205 is configured to track performance across different price segments of the comparable sales model and to define the physical market boundaries.

The confidence assessment module 206 implements through program code the logistic regression (or logit) model that estimates the probability that a given comparable sales model prediction is within 10 percent of the transacted price and assigns a confidence value to that regression. Further, the confidence assessment module 206 may consider characteristics that conform to the surrounding neighborhood to calculate the abnormality of a given comparable relative its neighborhoods, estimate a confidence value or prediction at the MSA level to reflect unique characteristics of each local market, and considers factors such as model performance, size, and quality of comparable pool to further enhance prediction accuracy.

The user interface and display module 207 manages the display and receipt of information from a user or other external source to provide functionality. It permits the management of the interfaces and inputs used to identify one or more changes, from which a determination of the corresponding comparables are selected, rated, or altered, and the displaying of the map images as well as the indicators of the subject property, the comparable properties, and confidence values. Further, the user interface and display module 207 permits the property data for the properties to be displayed in a tabular or grid format, with various sorting functions according to the property characteristics, economic distance, geographic distance, time, etc. That is, the user interface and display module 207 may be configured to provide mapping and analytical tools that implement the application. Mapping features allow the subject property and comparable properties to be concurrently displayed (and geographic regions to be selected using the customized neighborhood module 205). For example, mapping features include the capability to display the boundaries of census units, school attendance zones, neighborhoods, as well as statistical information such as median home values, average home age, etc. The mapping features also accommodate the illustration of geographical features of interest along comparable properties, offering visual depiction of properties that border the feature.

Additionally, a table or grid of data for the subject properties may concurrently be displayable so that the list of comparables can be manipulated, with the indicators on the map image updating accordingly. The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales

The automated valuation model 208 is configured to produce automated valuation of a subject based on a selection of comparables within a defined geographic area that the confidence value application 200A would have previously predicted.

The example of the application 200B of FIG. 2B includes the confidence assessment module 206 and the user interface and display 207, depicted in application 200A. In addition, the application 200B includes an input assessment module 203 that combines the functionality of each module 202, 204, and 205 of application 200A and includes the additional functionality described below regarding other input variables.

Further, the application 200B communicates with the automated valuation model 208, which is separate from the application 200B. It is understood that the automated valuation model 208 may be located externally or internally to a computer system that contains the application 200B (see FIG. 1B for an example). Thus, applications 200A-B may either integrate an automated valuation model or pull data from the automated valuation model using an API.

As described above regarding application 200A, more then the described modular breakdown of the application 200B may be implemented. Also, each module's functionality, whether shown or not shown, is further described in connection with below figures.

Further, the computer system described above may be a device (102a-c and 106a-c) that includes a central processing unit (CPU), an interface, and the value confidence applications 200A-B resident in a memory, where the application includes instructions that are executed by a CPU. The computer system may be a conventional desktop computer, a network computer, a laptop personal computer, a handheld portable computer (e.g., tablet, PDA, cell phone) or any of various execution environments that will be readily apparent to the artisan and need not be named herein. The interface may be any interface suited for input and output of communication data, whether that communication is visual, auditory, electrical, transitive, or the like.

The computer system runs a conventional operating system through the interaction of the CPU and the memory to carry out functionality by execution of computer instructions. The memory may be any memory suitable for storing data, such as any volatile or non-volatile memory, whether virtual or permanent. Operating systems may include but are not limited to Windows, Unix, Linux, and Macintosh. The computer system may further implement applications that facilitate calculations including but not limited to MATLAB. The artisan will readily recognize the various alternative programming languages and execution platforms that are and will become available, and the present invention is not limited to any specific execution environment.

Therefore, the application is preferably provided as software on the computer system described above, yet it may alternatively be hardware, firmware, or any combination of software, hardware and firmware. Still other embodiments include computer implemented processes described in connection with the application 200A-B as well as the corresponding flow diagrams.

A value confidence process will now be described below in relation to an example of a value confidence model and development data sample. The value confidence model development sample consists of nationwide purchase transactions with basic characteristic data readily populated to produce a comparable sales model prediction, in particular, with the minimum set of variables of AGE, LOT, GLA, and CBG. Further, Table 2. Input Variables for Creating Value Confidence Model (VCM) Variables provides a list of the variables for constructing the value confidence model, as well as the derived value confidence model variables. In addition, several of the VCM variables may first be converted into categorical variables before being used by the model.

TABLE 2
Input Variables for Creating VCM Variables

| Variable | Definitions |
|---|---|
| MEAN_AGE, | County-level mean of property age, lot size and gross |
| MEAN_LOT, | living area (GLA), respectively based on hedonic |
| MEAN_GLA | price model (HPM) estimation sample. |
| MED_BTH | County-level median number of baths based on HPM |
| | estimation sample. |
| STD_AGE, | Standard deviation of property age, lot size and GLA, |
| STD_LOT, | respectively based on HPM estimation sample. |
| STD_GLA | |

Comparable Sales Model (CSM) Outputs

| | |
|---|---|
| CSM_VAL_C | Calibrated CSM predicted value. |
| WECO | Weighted average of economic distance across comps |
| | (based on CSM weights). |
| COMPS | Number of model comps available for the subject |
| | property. |
| WABS_LOC | Weighted average of absolute value of location |
| | adjustment across comps (based on CSM weights). |
| WCOMP_VAL | Weighted average of comp values (unadjusted, based |
| | on CSM weights) |
| SIGMA | Standard deviation of CSM residual within VCM |
| | estimation set |
| CS5_FLG | Indicator of whether a property ran using five |
| | characteristics (CS5_FLG = 1) as opposed to three |
| | (CS5_FLG = 0). |

Transaction-Level Data

| | |
|---|---|
| AGE | Logged value of the age of property in years. |
| LOT | Logged lot size of property in square feet. |
| GLA | Logged gross living area of property in square feet. |
| BATH | Number of baths of the property. |
| BED | Number of beds of the property. |
| FCL | Foreclosure indicator for transaction. |
| CBG | Census block group of property. |
| WATER | Indicator of whether property is within 0.1 miles of an |
| | important body of water as indicated by inclusion in |
| | Navteq data. |
| AMT | Transaction amount. |

Derived VCM Variables

| | |
|---|---|
| GLA_D | Normalized versions of GLA, AGE and LOT, |
| AGE_D | respectively. |
| LOT_D | |
| BTH_D | Difference of BTH from its county-level median. |
| INV_SIGMA | Inverse of standard deviation (in $10K dollars) of |
| | CSM residual within VCM estimation set |
| PPE10 | Indicator of whether calibrated CSM prediction falls |
| | within 10 percent of the actual transacted price. |

One example of a value confidence model uses the 12 subject-level variables of county (CNTY_ID), logged age (AGE), logged lot size (LOT), logged gross living area (GLA), number of baths (BTH), foreclosure status (FCL), weighted average economic distance of comps (WECO), number of comps (COMPS), weighted average absolute location adjustment (WABS_LOC_ADJ), average price of comps (COMPVAL), whether the subject is within 0.1 miles of important water as indicated by inclusion in the Navteq water database (WATER), and the inverse of the average volatility measure for the subject (INV_SIGMA). The first six of these variables (CNTY_ID, AGE, LOT, GLA, BTH, and FCL) are known at the time of estimation of the hedonic price model (HPM). In particular, the HPM is based on county-level regression of logged transaction prices against observable property-level hedonic factors, including AGE, LOT, GLA, BTH and FCL, among others.

The next four variables (WECO, COMPS, WABS_LOC_ADJ, and WCOMPVAL) represent outputs from the CSM. In particular, the CSM produces a set of potential comparable properties for each property along with normalized weights of the importance of each comp in explaining the subject's value. The CSM also produces economic distance, absolute location adjustment and the value of the comp transaction, among other comp-level output. This output can be summarized at the subject-level to produce the VCM variables of WECO, COMPS, WABS_LOC_ADJ, and WCOMPVAL. The above reference to weighted average (WECO, WABS_LOC_ADJ, and WCOMPVAL) indicates the use of CSM weights to calculate averages across the comps for a given subject. In particular, those comps receiving higher weights from the CSM are relatively more important in determining these weighted average values.

The model volatility measure INV_SIGMA is based on the standard deviation of the CSM residual (actual transaction price minus the calibrated model value) at the CBG, tract or county-level. The VCM uses the smallest available geographic area that contains at least ten transactions in the development sample. The VCM calculates INV_SIGMA by dividing the estimated standard deviation by 10,000 (i.e. standard deviation is now in units of $10,000) and taking the inverse. The last explanatory variable WATER is a property-level characteristic that tells whether the property is within 0.1 miles of water (=1) or not (=0). This variable represents a potential driver of value not currently accounted for directly by the HPM and CSM and thus a potential predictable area where the model can fail.

Finally, the dependent variable in the model is PPE10, which captures whether or not the calibrated CSM prediction falls within 10 percent of the transaction price (YES=1, NO=0). Further, the calibrated CSM value, as well as the uncalibrated value, is returned at the time of Datappraise.

As explained earlier, the CSM provides less reliable predictions for properties that are less conforming or dissimilar to their neighborhoods. First, the coefficients estimated during the HPM stage may be less applicable at describing the value of a dissimilar property's characteristics than for a more representative property. Second, properties that are not like their neighbors can potentially end up with comp pools that are smaller in size and consisting of properties less like itself compared with the pools of other more representative properties.

The VCM measures the dissimilarity of a property along the dimensions of GLA, LOT, AGE and number of bathrooms. Three continuous variables GLA, LOT and AGE are transformed to their deviation from the county average and then divided by standard deviation. This normalization captures how far the subject is from the average property of the county along a given dimension. Both mean and standard deviation are based on the HPM estimation sample. For instance, the transformation of GLA is

$${GLA\_D}_{i} = \frac{{GLA}_{i} - {MEAN\_GLA}_{i}}{{STD\_GLA}_{i}} . \qquad ( Eq . 3 )$$

Here, MEAN_GLAᵢ and STD_GLAᵢ represent the mean and standard deviation, respectively, of the logged value of GLA across the transacted properties within a given county. This amounts to a normalized transformation for GLA. The variables AGE and GLA are transformed in an analogous fashion.

The transformation of the discrete variable BTH, with a more limited number of observed values, is

BTH_{—}Dᵢ=BTHᵢ−MED_{—}BTHᵢ. (Eq. 4)

Here, MED_BTH represents the median values of bathrooms across the transacted properties of a given county.

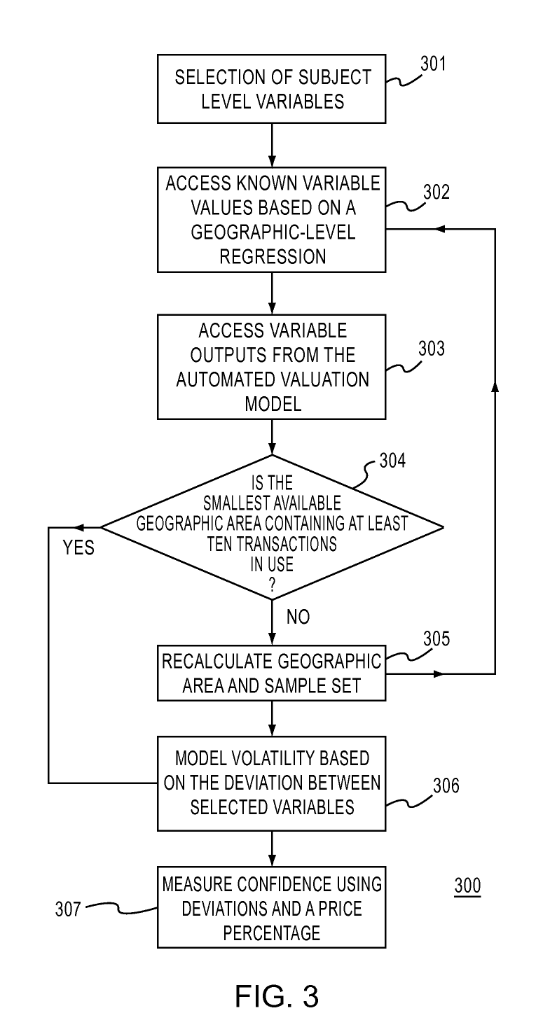

FIG. 3 is a flow diagram illustrating an example of a value confidence process. Specifically, FIG. 3 is a flow diagram illustrating an example of the value confidence process 300 that describes one possible operation sequence for the applications 200A-B. The value confidence process begins with the selection 301 of subject-level variables. For example, 12 subject-level variables may be selected. The variable values are then accessed 302 on a per property basis (of the properties in the sample) from the property data resources, as described above, and accessed 303 from the automated valuation model through the API or through the automated valuation model's integration with the value confidence model. In other words, accessing variable values includes receiving the broad model inputs of a set of property characteristics, model uncertainty, comparable strength, market segmentation, and geographic area based on the variable construction methods. The accessing (302 and 303) by the value confidence process is performed by the application modules as described above (i.e. input assessment module 203).

The value confidence model next checks 304 whether the sample is the smallest available geographic area with at least ten transactions. If it is found that the current sample of properties is the smallest available geographic area containing at least ten transaction then the process 300 models 306 the volatility of the sample based on the deviation between the selected variables. Further, the value confidence process 300 measures 307 the confidence that a model prediction will be within a specified price percentage. For example, that the price percentage may be a value within ±10 percent.

If it is found that the current sample of properties could be further limited based on geographic restriction while maintaining the integrity of the sample then the confidence value process 300 recalculates 305 the geographic area and sample set. After recalculation 305, the process may again accesses (302 and 303) the variable values. This measure may eliminate over utilization of data resources. Alternatively, the process could proceed directly to modeling 306 volatility while implementing a clear or drop on those properties and value that lie outside the recalculated geographic area.

Now further description will be given below regarding selection of the subject-level variables, their manipulation, and testing a value confidence model. It is preferable that cutoffs are implemented to regulate an inclusive upper bound of the model inputs, such that the appropriate relevant points of the distribution are provided as an input for the value confidence model's calculation.

For example, Table 3. Cutoffs for Assigning Categories of VCM Variables lists the cutoffs for variables AGE_D, LOT_D, GLA_D, BTH_D, WECO, WCOMPVAL, WABS_LOC_ADJ, and COMPS based on variable behavior. That is, if a property has a normalized AGE of −0.75, it receives a categorical value of 01, if −0.25 then it receives a value of 02 and so on. BATH_D is an exception, where BATH_D is assigned a value of 01 if less than or equal to −2, a value of 02 if greater than or equal to 2 and a value of 03 if greater than −2 but less than 2. Assigning the highest numbered category (03) to the center of the bath distribution allows interpretation of the coefficients in the logit to be relative to this central category.

TABLE 3
Cutoffs for Assigning Categories of VCM Variables

| Variable | Cutoffs |
|---|---|
| AGE_D_CAT | −0.5, 0, 0.5, 1, 2 |
| LOT_D_CAT | −1.5, −0.5, 0.5, 1, 2 |
| GLA_D_CAT | −2, −1, 0, 1, 2 |
| BATH_D_CAT | −2, 2 |
| WECO_CAT | 5%, 25%, 50%, 75%, 95% |
| WCOMPVAL_CAT | 17%, 34%, 51%, 68%, 85% |
| WABS_LOC_ADJ | 5%, 25%, 50%, 75%, 95% |
| COMPS_CAT | 3, 10 |

For the variables WECO, WCOMPVAL, and WABS_LOC_ADJ the cutoffs are based on the county-level percentiles of the distribution. If a county has less than 50 observations in the estimation set, then the entire MSA-level distribution is used to define the cutoff.

In addition, variables that enter the model as categorical are denoted with the variable name followed by _CAT. The remaining model variables consist of two dummy variables (WATER and FCL) and one continuous variable (INV_SIGMA).

Two versions of the value confidence model were tested. The MSA-Level Version of the Model estimated a confidence factor for those subjects at the MSA-level providing an MSA had at least 50 observations in the development sample. The State-Level Version for Small MSAs and Non-MSA Properties estimated, which includes all remaining observations in the state, a confidence factor for those MSAs with less than 50 observations or those properties not in an MSA. In the State-Level Version version, the model used only a limited number of variables including WECO, COMPS, INV_SIGMA and county-level fixed effects.

Thus, the model was run, using both versions, to produce estimation results for the nine example MSAs listed in Table 1. These estimates reveal that the reliability of the comparable sales model tends to increase as the age of properties decrease, as the weighted average economic distances across comps decrease, as the weighted average absolute location adjustments across comps decrease (statistically insignificant), as the number of comps increases and as the average value of comps increases. Furthermore, the model is more reliable when dealing with a non-water property and for properties in areas with lower comparable sales model residual volatility. The GLA, LOT and BTH coefficients all reflect, to some degree, the notion that the comparable sales model is better at explaining prices for properties with characteristics from the central parts of the distribution as opposed to those with characteristics from more extreme parts of the distribution. For the Washington, DC metro area the model does better at explaining the non-foreclosure properties. These general patterns are for the most part confirmed by the estimation results for the other MSAs.

The general functional form for testing each version of the model is given as:

Pr(PPE10ᵢ=11 X ᵢ)=f(INV_SIGMAᵢ, NHD_{—}CONSᵢ) . (Eq. 5)

Each version the model is estimated and tested over a period of one year. In one test, the versions of the value confidence model are compared to a preponderance model, where predictions are based on naively providing a prediction of PPE10 based on the most observed outcome across a subset of properties. For instance, if over the entire estimation sample, a modeler observes average PPE10 of 0.4, they would predict that none of the properties will be within 10 percent of the transacted prices if following the preponderance model.

Further, two performance measures for the logistic regression were uses. 1) The Gini coefficient measures rank-order power of the model. 2) Concordance measures false positives and false negatives of actual binary predictions. In the value confidence estimation set, PPE10 ranges from 15 percent to 68 percent at the MSA level, and models are estimated at the MSA/state level. Note, there is not a single national cutoff for acceptable prediction that can be applied to each property. Furthermore, rank-order power is not as important as actual concordance for the decision of whether or not there is sufficient confidence in the comparable sales model output for a given transaction.

To predict PPE10 from the logit-based probability, the value confidence model relies on cutoffs that match the share of PPE10 in each MSA/state sample. Specifically, the predicted probabilities are ranked in descending order at the MSA/state level and the top X % of probabilities are designated as being predictions of PPE10 =1 while the bottom 1-X % are predictions of PPE10=0, where X % is the percentage of PPE10=1 in the in-sample.

The first model tested is the benchmark version of the model, which mimics the CVCS used in the production AVM. This model consists of three variables: an intercept, a volatility measure and a neighborhood consistency measure. The neighborhood consistency measure is calculated by comparing the predicted value of the property to its neighbors, defined as those properties in the development sample that are in the same geographical area as the subject. The choice of the geographic area (CBG, tract or county) matches that used to calculate the volatility measure (see above).

The neighborhood consistency measure in this logistic regression is not significantly estimated (results not shown). Also, model volatility is the most important measure in explaining variations in the reliability of the automated valuation model. Thus, the model volatility measure is included in the value confidence model but the neighborhood consistency measure is not included.

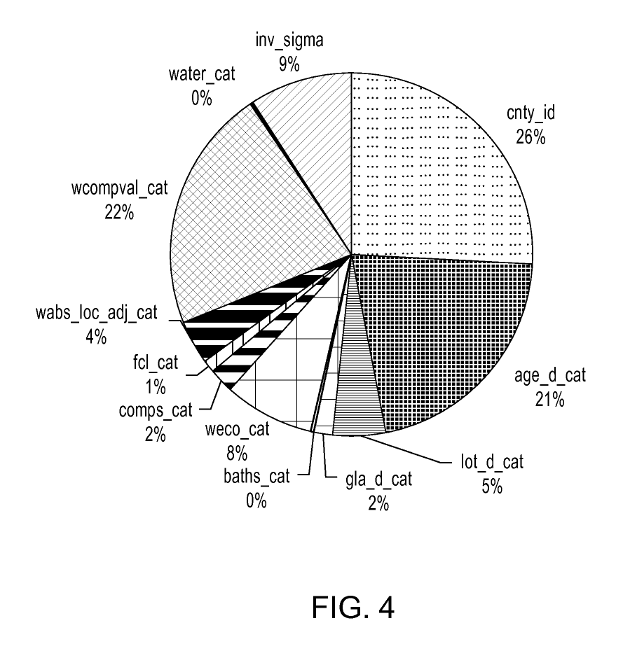

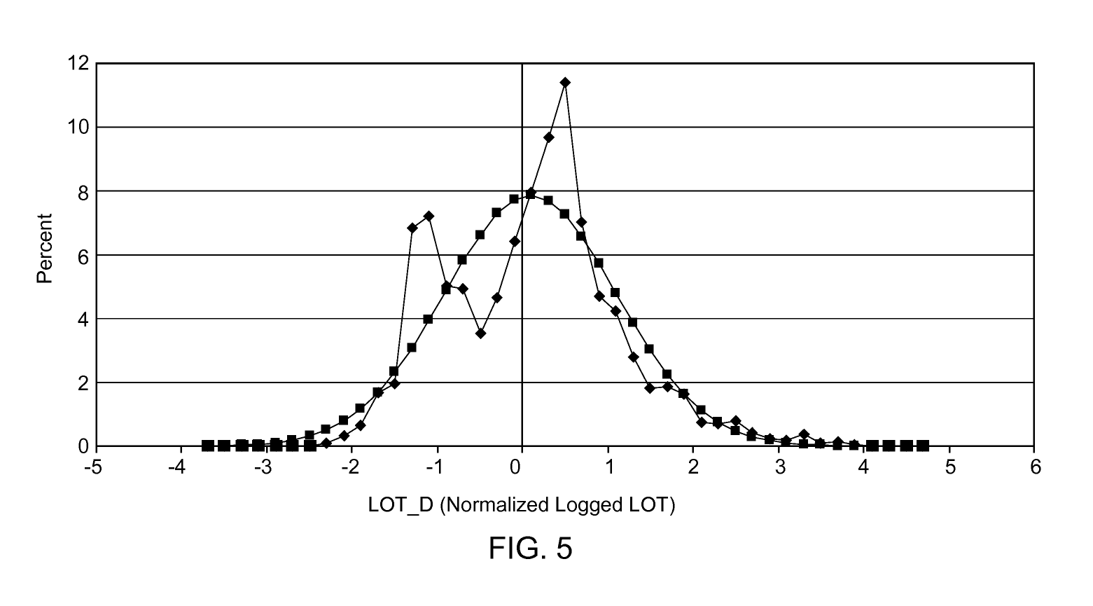

To better understand the variable categorization and contribution, FIGS. 4 and 5 are provided. FIG. 4 is a pie graph showing a contribution to PPE10 Variation in VCM for Washington, DCA MSA. FIG. 5 is a line graph showing a normalized logged LOT Variable vs a Normal Distribution for Washington, DC MSA.

Specifically, FIG. 4 presents the contribution of the various inputs in the MSA model to explaining PPE10 for the Washington, DC MSA for an estimation sample period of one year. Overall, the contribution to variation seems to be dominated by CNTY_ID, AGE_D, WCOMPVAL, INV_SIGMA and WECO, while variation across many of the other variables seem to explain little of the differences observed in PPE10 in the Washington, DC MSA. Variables can still be significant in explaining observed PPE10 behavior across a particular subset of properties (i.e. foreclosed sales), but only affect the overall variation of PPE10, particularly if the subset of properties is small.

FIG. 5 shows the distribution of the normalized transformation of LOT for the Washington, DC MSA (MSA_ID=47900) for the same one year estimation period as FIG. 4. Note, how the Lot sizes cluster around two values, correspondingly roughly to −1 and 0.5. When taking the average PPE10 across the same values of LOT, the value confidence model shows that the comparable sales model performs relatively better at these more populated points of the distribution and relatively worse with large lot sizes. Similar results were found with GLA, revealing that the comparable sales model performs relatively poorly on properties with lower square footages and relatively well towards the center of the distribution compared with the extreme edges. Further, the value confidence model simulations have shown that despite the relative preponderance of transactions involving older properties in the Washington, DC MSA, comparable sales model performance decreases nearly monotonically as age increases, which results from over-penalizing older properties in the CSM based on the negative HPM coefficient on AGE.

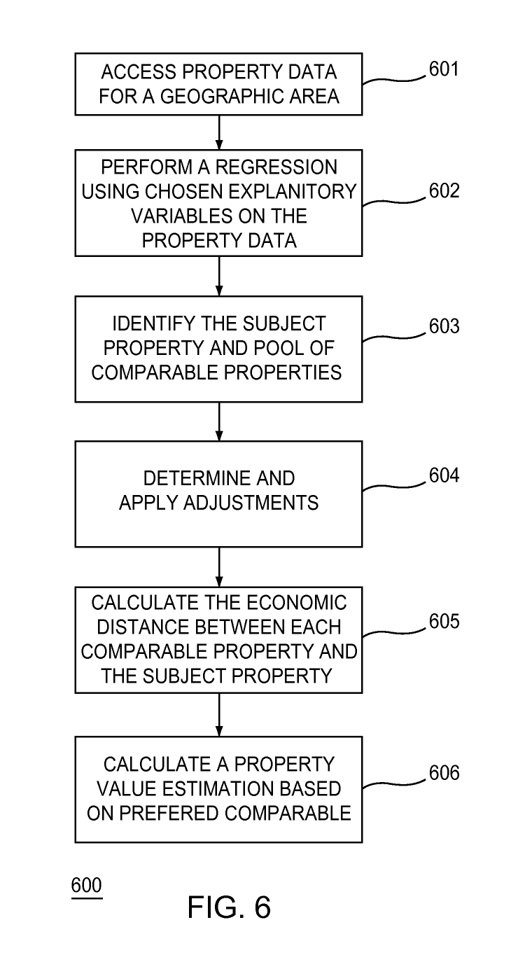

FIG. 6 is a flow diagram illustrating an example of an automated valuation process. Specifically, FIG. 6 is a flow diagram illustrating an example of the automated valuation process 600, which may be performed by an aspect of the confidence factor application or an automated valuation application itself, where a subject is automatically values based on a set of comparables.

The automated valuation application accesses 601 property data. This is preferably tailored at a geographic area of interest in which a subject property is located (e.g., county or CBG). A regression 602 modeling the relationship between price and explanatory variables is then performed on the accessed data that may be located on the property data resources described above. Although various alternatives may be applied, a preferred regression uses the explanatory variables of GLA, lot size, age, number of bathrooms, and geographic location, as well as the categorical fixed effects of location, time, and foreclosure status.

A subject property within the county is identified 603 as is a pool of comparable properties. The subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

Once the pool is established, a set of adjustment factors is determined 604 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 604, the “economic distance” between the subject property and respective individual comparable properties is determined 605. The economic distance may be constituted as a quantified value representative of the estimated price difference between the two properties as determined from the set of adjustment factors for each of the explanatory variables.

Following determining of the economic distance, a valuation is calculated 606 for the subject based on the selected comparable properties, adjustments to those properties, and economic distance calculation. The comparable properties may also be weighted (sorted in a preferred order) in support of generating a valuation of the subject. Once the process 600 has completed, the information may be conveyed to the user in the form of grid and map image display to allow convenient and comprehensive review and analysis.

In view of the above, the value confidence model is implemented at the time of Datappraise with coefficients based on the most recent transactions available. Further, to calculate probability and confidence decision (=1 if sufficiently confident in the CSM, 0 otherwise) a set of county-level coefficient files and distribution points are used for each county that take as inputs the variables described in Table 2. Thus, the value confidence model is generally implemented in two applications (appraisal review and automated valuation).

In appraisal review, the value confidence model is used as an input into an appraisal scorecard application. In particular, the value confidence model may be used by the scorecard application to determine whether there is sufficient confidence in comparable sales model's evaluation of a property and thus whether the comparable sales model can be used to evaluate observed appraiser behavior.

In property valuation, value confidence model involves providing a confidence measure to support an automated valuation model. Thus, in any application in which the automated valuation model is used to provide a value for the property, the value confidence model can be used to provide a confidence level for this value.

Thus, embodiments of the described produce and provide methods and apparatus for a model for evaluating appraisals by comparing their comparable sales with selected comparable sales. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for automatically assigning confidence ratings to properties valued by an automated valuation model, comprising:
determining a set of typical property variables for properties in a geographic area;
automatically determining a deviation from the set of typical property variables for a candidate comparable property; and
assigning a confidence factor to an automated valuation of the candidate comparable property based upon the deviation.

2. The method according to claim 1, wherein the set of typical property variables includes a set of property characteristics, model uncertainty, comparable strength, market segmentation, and geographic area.

3. The method according to claim 1, wherein determining a set of typical property variables for properties in a geographic area includes selection of a set of subject-level variables.

4. The method according to claim 1, further comprising:
determining whether the geographic area is the smallest available geographic area with at least ten transactions.

5. The method according to claim 4, further comprising:
determining a new geographic area and selecting a set of properties in the new geographic area and determining a set of typical property variables for properties in the new geographic area, when the geographic area is not the smallest available geographic area with at least ten transactions.

6. The method according to claim 1, wherein assigning a confidence factor to an automated valuation of the candidate comparable property based upon the deviation includes estimating a probability that the automatic valuation is within ±10 percent of a value.

7. The method according to claim 1, wherein assigning a confidence factor to an automated valuation of the candidate comparable property based upon the deviation includes applying a logistic regression that estimates a probability that a given comparable sales model prediction is within 10 percent of the transacted price.

8. A computer program product stored on a non-transitory computer readable medium that when executed by a computer performs a method for automatically assigning confidence ratings to properties valued by an automated valuation model, the method comprising:
determining a set of typical property variables for properties in a geographic area;
automatically determining a deviation from the set of typical property variables for a candidate comparable property; and
assigning a confidence factor to an automated valuation of the candidate comparable property based upon the deviation.

9. A method for automatically assigning confidence ratings to properties valued by an automated valuation model, comprising:
means for determining a set of typical property variables for properties in a geographic area;
means for automatically determining a deviation from the set of typical property variables for a candidate comparable property; and
means for assigning a confidence factor to an automated valuation of the candidate comparable property based upon the deviation.

10. An apparatus that automatically rates a quality of appraisal selected comparables, comprising:
a circuit that determines a set of typical property variables for properties in a geographic area, that automatically determines a deviation from the set of typical property variables for a candidate comparable property, and that assigns a confidence factor to an automated valuation of the candidate comparable property based upon the deviation; and
a display that displays using the confidence factor a quality list of the candidate comparable property and appraisal selected comparables.

11. A method for automatically assigning confidence ratings to properties valued by an automated valuation model, comprising:
sampling the properties valued by the automated valuation model to render a set of consistent property characteristic;
identifying an outlier of the properties valued by the automated valuation model using a deviation threshold;
analyzing the outlier based on the set of consistent property characteristics; and
assigning a first confidence value when the set of consistent property characteristics matches a set of characteristics of the outlier and a second confidence value when the set of consistent property characteristics is different from the set of characteristics of the outlier.
